(19) United States
(12) Patent Application Publication
(10) Pub. No.: US 2026/0141898 A1
(43) Pub. Date: May 21, 2026

(54) STREAMING LONG-FORM SPEECH RECOGNITION

(71) Applicants: Yu WU, Redmond, WA (US); Jinyu LI, Redmond, WA (US); Shujie LIU, Redmond, WA (US); Xun GONG, Redmond, WA (US); MICROSOFT TECHNOLOGY LICENSING, LLC, Redmond, WA (US)

(72) Inventors: Yu WU, Beijing (CN); Jinyu LI, Bellevue, WA (US); Shujie LIU, Beijing (CN); Xun GONG, Beijing (CN)

(21) Appl. No.: 19/121,664

(22) PCT Filed: Oct. 19, 2022
(86) PCT No.: PCT/CN2022/126111

§ 371 Date: Apr. 16, 2025

(51) Int. Cl. G10L 15/22; G06N 3/045; G10L 15/16

(52) U.S. Cl. CPC G10L 15/22; G06N 3/045; G10L 15/16

(57) ABSTRACT

Systems and methods are provided for accessing a factorized neural transducer comprising a first set of layers for predicting blank tokens and a second set of layers for predicting vocabulary tokens. The first set of layers comprises a blank predictor, an encoder, and a joint network and the second set of layers comprising a vocabulary predictor which is a separate predictor from the blank predictor. A context encoder is added to the factorized neural transducer which encodes long-form transcription history for generating a long-form context embedding, such that the factorized neural transducer is further configured to perform long-form automatic speech recognition, at least in part, by using the long-form context embedding to augment a prediction of vocabulary tokens.

### BACKGROUND

Automatic speech recognition (ASR) systems and other speech processing systems are used to process and decode audio data to detect speech utterances (e.g., words, phrases, and/or sentences). The processed audio data is then used in various downstream tasks such as search-based queries, speech to text transcription, language translation, etc. There are many different types of ASR systems that are being explored. For example, end-to-end (E2E) ASR systems, such as connectionist temporal classification (CTC), attention-based encoder-decoder, and transducers each work to transfer acoustic features to text sequences. This speech-to-text process is typically focused on processing each utterance independently, in part because the models are trained on short-form speech (e.g., utterances comprising less than one minute of speech each). Thus, such models excel in short-form speech processing, such as voice queries and voice commands.

However, other types of speech are not as suitable for processing by models that excel in processing short-form speech. For instance, some types of speech like conversations, meetings, and storytelling usually comprise long-form speech that is not suitable for being processed by ASR models that have architectures and training processes tuned for processing short-form speech. In view of the foregoing, there is a need for improved methods and systems for performing long-form automatic speech recognition.

The subject matter claimed herein is not limited to embodiments that solve any disadvantages or that operate only in environments such as those described above. Rather, this background is only provided to illustrate one exemplary technology area where some embodiments described herein may be practiced.

### SUMMARY

Disclosed embodiments include systems and methods for performing long-form speech recognition. In particular, systems and methods are provided for compiling and/or modifying a machine learning model, such as factorized neural transducer, to perform long-form speech recognition. Additionally, systems and methods are provided for processing long-form speech data.

Disclosed embodiments are provided for modifying a factorized neural transducer to perform long-form automatic speech recognition. Some of the disclosed systems, for example, are configured to access a factorized neural transducer comprising a first set of layers for predicting blank tokens and a second set of layers for predicting vocabulary tokens. The first set of layers comprising a blank predictor, an encoder, and a joint network, wherein a blank predictor output from the blank predictor and an encoder output from the encoder are processed by the joint network for predicting the blank tokens. The second set of layers comprising a vocabulary predictor which is a separate predictor from the blank predictor, wherein a vocabulary predictor output from the vocabulary predictor and the encoder output are used for predicting the vocabulary tokens. The systems then add a context encoder to encode transcription history for generating a long-form context embedding, such that the factorized neural transducer is further configured to perform long-form automatic speech recognition, at least in part, by using the long-form context embedding to augment a prediction of vocabulary tokens.

Disclosed embodiments also include systems and methods for using a factorized neural transducer to perform long-form automatic speech recognition. For example, system access a factorized neural transducer comprising a first set of layers that predict a blank token and a second set of layers that predict a vocabulary token. In particular, a long-form context encoder used in at least the second set of layers is used to generate a long-form context embedding based on long-form transcription history to be used in predicting the vocabulary token.

Disclosed systems are also configured to obtain and transmit electronic content comprising speech data as input to the factorized neural transducer and to subsequently predict the blank token, generate a vocabulary prediction output, and generate a long-form context embedding. The disclosed systems are also configured to predict the vocabulary token based on a combination of the vocabulary prediction output and the long-form context embedding.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be limiting in scope, embodiments will be described and explained with additional specificity and detail through the use of the accompanying drawings in which:

FIG. 1 illustrates an example embodiment of a conventional neural transducer.

FIG. 2 illustrates an example embodiment of a factorized neural transducer.

FIG. 3 illustrates an example of a factorized neural transducer that has been modified to perform long-form speech recognition.

FIG. 4 illustrates various examples of different methods for modifying the factorized neural transducer to perform long-form speech recognition.

FIG. 5 illustrates an example embodiment of a flow diagram having a plurality of acts for modifying a factorized neural transducer to perform long-form speech recognition.

FIG. 6 illustrates one embodiment of a flow diagram having a plurality of acts associated with using a factorized neural transducer that has been modified to perform long-form speech recognition.

FIG. 7 illustrates an example computing environment in which a computing system incorporates and/or is utilized to perform disclosed aspects of the disclosed embodiments.

### DETAILED DESCRIPTION

Disclosed embodiments are directed towards improved systems, methods, and frameworks for modifying and using a factorized neural transducer for long-form speech recognition.

The disclosed embodiments may be utilized to realize many technical benefits and advantages over conventional systems and methods for processing long-form speech recognition, as well as for generating and modifying machine learning models that are capable of performing the long-form speech recognition. The technical benefits and advantages that may be realized, for example, include the ability to generate factorized neural transducers which comprise separate prediction networks for predicting blank tokens and vocabulary tokens, as well as the ability to perform ASR tasks on long-form speech with increased accuracy relative to accuracy that is possible with models tuned for short-form speech.

As described herein, various embodiments are also provided for further modifying factorized neural transducers to obtain even greater accuracy when performing ASR tasks. The disclosed additional modifications that can be made to the factorized neural transducers include, but are not limited to: (1) implementing CTC criterion into the training process to provide for faster, more efficient training processes, with improved prediction functionality; (2) combining the encoder output and vocabulary predictor output prior to generating the vocabulary token prediction to allow learned acoustic information to improve the prediction of the vocabulary token; (3) add a context encoder to generate a long-form context embedding; (4) combining the long-form context embedding with the vocabulary predictor output to improve the prediction of the vocabulary token; and (5) injecting the long-form context embedding into the vocabulary predictor to improve the vocabulary predictor output. The foregoing benefits are especially pronounced in real-time applications for streaming audio.

### Conventional Neural Transducers

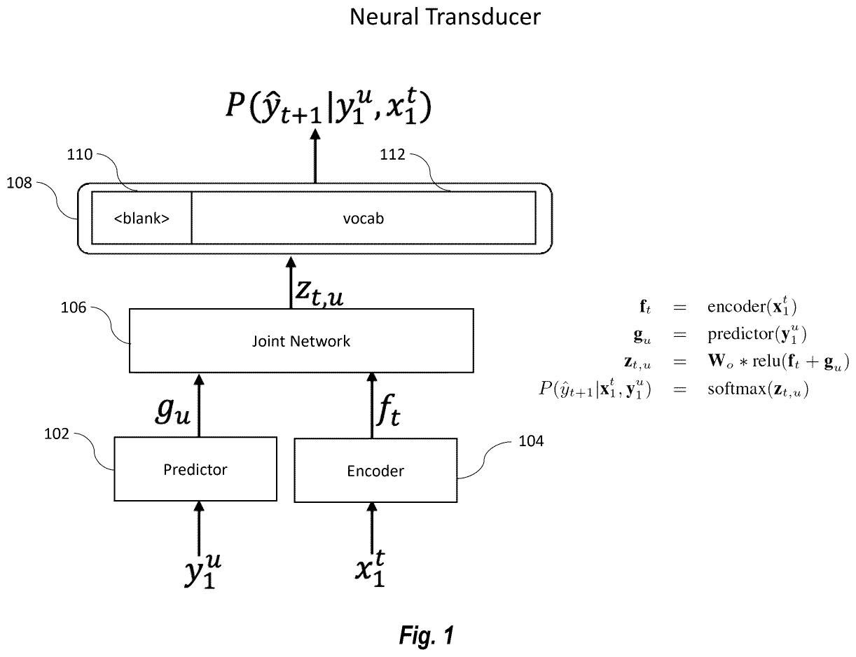

Attention will first be directed to FIG. 1, which illustrates an example embodiment of a conventional neural transducer configured to perform speech recognition on short-form speech. As illustrated, the conventional neural transducer comprises a predictor 102, an encoder 104, and a joint network 106. The predictor takes input (e.g., “y”) comprising a previously predicted non-blank output (e.g., historical label sequence) to generate a prediction output (e.g., “g”), which is a label representation. The encoder takes input (e.g., “x”) comprising acoustic features associated with a portion of speech data to generate an encoder output (e.g., “f”), which is an acoustic representation. The joint network generates a joint output (e.g., “z”) based on the prediction output and the encoder output. The joint output is then used to generate a final prediction 108 for a corresponding portion of speech data, which includes a blank token 110 and vocabulary token 112, which results in a probability distribution over the output layer. Notably, the predictor 102 is configured in the conventional model to predict both the blank token 110 as well as the vocabulary token 112, such that the training and results of the two types of potential tokens are tied together.

In order to address the length differences between the acoustic feature and label sequences, a special blank symbol is added to the output vocabulary to represent a null token. Each alignment contains a particular number of output tokens. The objective function of the transducer model is to minimize the negative log probability over all possible alignments.

In recent years, E2E based automatic speech recognition systems like the neural transducer illustrated in FIG. 1 have achieved success due to their simplicity and promising performance and are able to outperform traditional hybrid models in some scenarios. However, the joint optimization of the acoustic model and lexicon and language model in the neural transducer also brings significant challenges in adapting the ASR system. For example, neural transducers such as those illustrated in FIG. 1 must use adaptation training data that comprises audio-text pairs.

Conventional models, such as those referenced in FIG. 1, are not easily tuned/trained for new domains using only adaptation text. This makes adaptation tasks more costly, both in money spent curating the appropriate dataset and in computational processing, which must use the audio data along with the corresponding textual data to adapt an ASR system for new domains. In particular, conventional models must use the audio-text pairs because the blank token and vocabulary token are predicted jointly using the same predictor, as previously noted.

Notably, there are no individual acoustic and language models used for performing ASR tasks in the conventional neural transducer space. Additionally, although the predictor of the transducer looks similar to a language model in terms of model structure (i.e., an internal language model could be extracted from the predictor and joint network), it does not perform as a language model because the predictor needs to coordinate with the acoustic encoder closely. Hence, it is not straightforward to utilize text-only data to adapt the model from a source domain to a target domain. This especially limits the ability to perform fast adaptation, for example, because the entire model must be adapted.

Additionally, when a conventional model attempts to adapt its neural transducer to new domain, it experiences significant degradation in its ability to perform speech recognition in the original domain due to the architecture and weighting applied by the neural transducer to the new domain.

The foregoing drawbacks have hindered the use of neural transducers in many different ASR applications. While there have been some efforts made to mitigate or solve these shortcomings, such approaches have been computationally expensive and are not practical for applications requiring fast adaptation.

### Factorized Neural Transducer

In light of the foregoing limitations of conventional neural transducers, some disclosed embodiments are directed to an improved neural transducer which factorizes the blank and vocabulary prediction. This factorization allows for the language model portion (e.g., vocabulary prediction layers) of the factorized neural transducer to be adapted independently from the blank prediction layers. This disentangles the fusion of the language model and acoustic model typically experienced in traditional E2E models (i.e., conventional neural transducers) and allows for efficient language model adaptation and customization.

For example, because the factorized neural transducer has been optimized to allow the vocabulary prediction layers to behave more like a standalone language model, variety and number of adaptation techniques that can be applied is significantly increased. Additionally, the original benefits of using a transducer model, such as minimizing the negative log probability over all possible alignments of the output tokens.

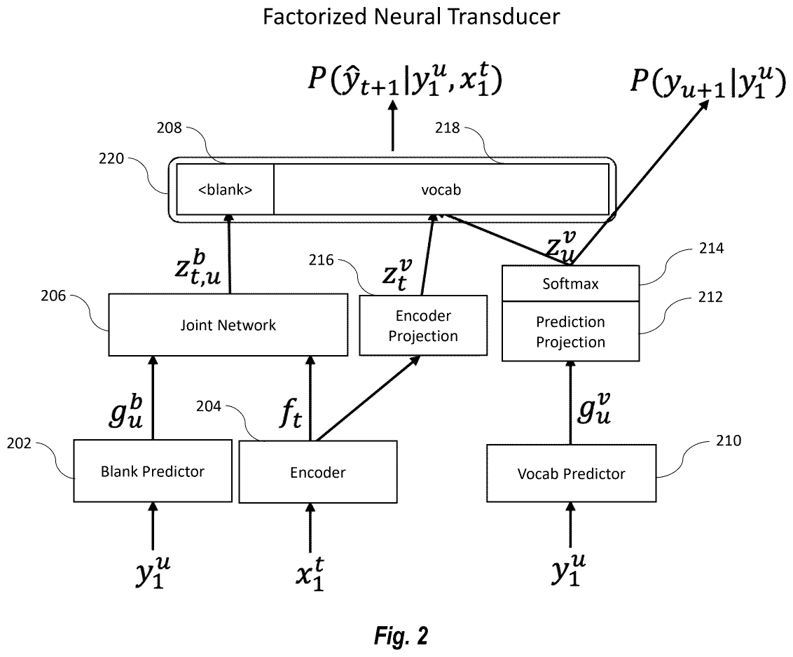

Attention will now be directed to FIG. 2, which illustrates an example embodiment of a factorized neural transducer. As illustrated, the factorized neural transducer comprises a blank predictor 202, and encoder 204, a joint network 206, and a vocabulary predictor 210, which is functionally separated from the blank predictor 202 in the architecture of the factorized neural transducer.

In this factorized architecture, the blank token 208 and vocabulary token 218 are predicted separately, as part of the generation of the label output 220. For example, the blank predictor 202 generates a blank predictor output (e.g., “g”) based on receiving a previously predicted non-blank label output (“y”) and corresponding to a previous portion of speech data.

The encoder 204, meanwhile, generates an encoder output (e.g., “f”) based on receiving a set of acoustic features (e.g., “x”) extracted from a portion of speech data.

The joint network 206 generates a joint output (e.g., “z”) based on the blank predictor output and the encoder output. The system is then able to predict the blank token 208 based on the joint network output.

For the prediction of the blank token, it is important to fuse the acoustic and label information as early as possible, thereby enabling the combination to occur at the joint network.

In contrast to conventional neural transducers, the predictor of the factorized transducer does not need to coordinate with the encoder output in order to predict the corresponding output token. In addition, it avoids generating repeated label tokens, which can sometimes happen in conventional systems because each label normally consists of multiple acoustic frames. Instead, the acoustic encoder output is shared between the two predictors to extract the acoustic representation, but with slightly different combinations.

In series, or in parallel, with predicting the blank token, the factorized neural transducer also predicts the vocabulary token 218. For example, the vocabulary predictor 210 generates a vocabulary predictor output (e.g., “g”). Subsequently, a prediction projection layer 212 and a Softmax layer 214 are consecutively applied to the vocabulary predictor output in order to generate output “z”. An encoder projection layer 216 is also applied to the encoder output in order to generate output “z”. The system then predicts the vocabulary token 218 based on output “z” and output “z”. Because of the factorization, the vocabulary predictor is allowed to behave like a language model, using history words as input and the log probability of each word as output.

By implementing an ASR system in this manner, it has been found that the factorized neural transducer can achieve 15.4% to 19.4% word error rate (WER) improvements, compared to conventional transducer ASR models, when out-of-domain text data is used for language model adaptation (e.g., when adapting the vocabulary prediction layers). Additionally, the current factorized neural transducer model is able to retain a similar WER as the original training stage on a general test set, with minimal degradation, even after applying training for a new domain.

The system is configured to compute a transducer loss corresponding to the first set of layers which predict the blank token. The objective function of the transducer model is to minimize the negative log probability over all possible alignments between the acoustic features and label sequences. The system is also configured to compute a language model loss, accounting for cross-entropy, corresponding to the second set of layers which predict the vocabulary token. The language model loss is combined with the transducer loss by subtracting the language model loss from the transducer loss. In some instances, the weighting factor is determined and applied to the language model loss.

The loss function of the factorized neural transducer can be written as:

$${J}_{f} = {J}_{t} - λ * log P ( {y}_{1}^{U} )$$

where the first term is the transducer loss, and the second term is the language model loss with cross entropy. Lambda is a hyper-parameter (i.e., weighting factor) to tune the effect of language model loss as it contributes to the loss function of the factorized neural transducer.

The vocabulary prediction network (e.g., the vocabulary predictor, prediction projection layer, and Softmax layer) generates an output that is the log probability over the vocabulary. Because the vocabulary prediction is allowed to function as a standalone language model, this internal language model can be replaced by any language model trained with the same vocabulary. There is no large matrix computation in the factorized neural transducer in the joint network as compared to the traditional neural transducer. As a result, the training speed and memory consumption is improved.

In the training stage, the factorized neural transducer is trained from scratch using a loss function. Thereafter, within the adaptation stage, the model can be further trained using any language model adaptation technique to adapt the vocabulary prediction network, including using text-only adaptation data. This is a great technical benefit since is it much easier to collect a large scale of text data than to collect labeled speech data.

### Modified Factorized Neural Transducer

Some disclosed embodiments are also directed to further modifications of the factorized neural transducer and which are specifically aimed at optimizing the factorized neural transducer for long-form speech recognition. Real speech recognition scenarios like conversation, storytelling or meetings are usually a long-form situation. Long-form ASR (or conversation ASR, dialog-aware ASR, large-context ASR) is a special version of ASR architecture which improves the ASR performance by capturing the relationship among the consecutive historical sentences while decoding the current sentence. Previous speech and transcription history greatly improve ASR performance, especially in streaming, long-form situations. For example, some keywords mentioned before will be repeated later in the conversation, or the same acoustic environment can be used to guide the recognition in the future.

Various embodiments will now be provided to illustrate how the factorized neural transducer can be further modified for processing long-form information by the factorized neural transducer. The benefits and accuracy of processing long-form information with the disclosed factorized neural transducers are greatly magnified in comparison to the processing of long-form information in conventional neural transducers. This is because, in conventional neural transducers, the prediction network does not behave as a standalone language model, which limits its capability in long-form transcription modeling. By splitting out the language model from the architecture (i.e., factorizing), the long-form information is more effectively processed.

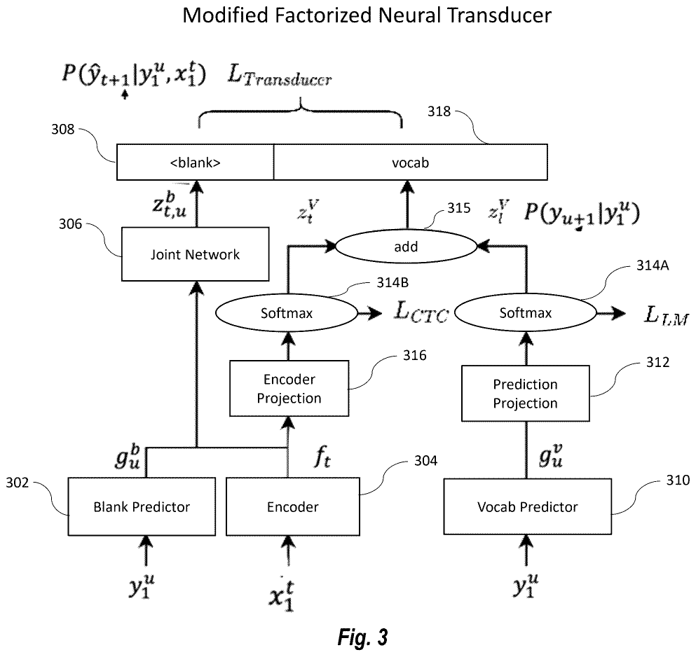

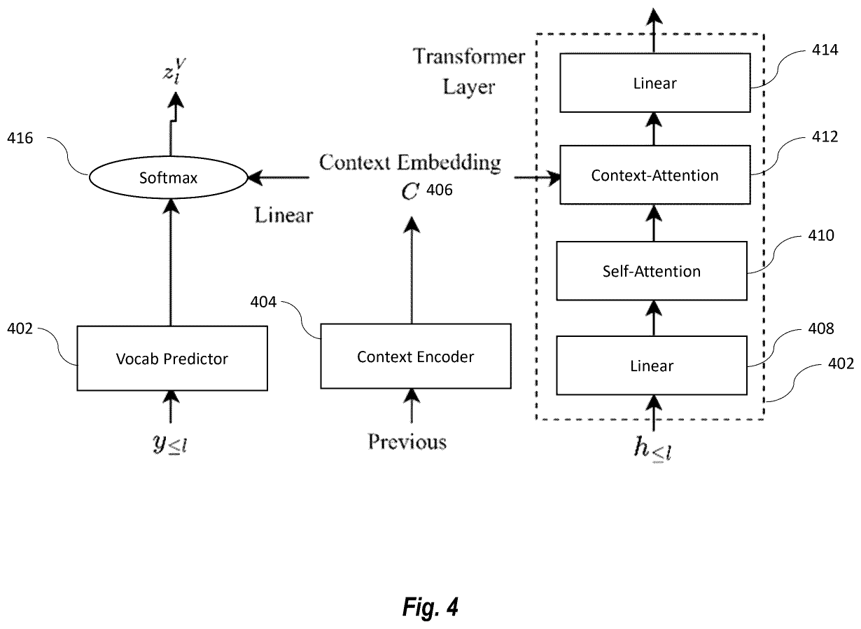

Attention will now be directed to FIGS. 3 and 4, which illustrate examples of a factorized neural transducer that has been modified for long-form speech recognition. The architecture in FIG. 3 is referred to as a modified factorized neural transducer (M-FNT), as there are some modifications over the FNT model illustrated in FIG. 2. Similar to the factorized neural transducer illustrated in FIG. 2, the M-FNT aims to separately predict blank tokens and normal tokens (i.e., vocabulary tokens), so that the prediction of normal tokens fully functions as a language model.

The M-FNT model comprises four main parts, the encoder 304, the blank predictor 302, the joint network 306, and the vocabulary predictor 310. In some instances, the encoder 304 is an acoustic encoder, which consumes long-form speech history (e.g., speech signal and/or audio data). Some modifications of the FNT model include an encoder projection layer 316 which is applied to the encoder output (i.e., acoustic representation). A Softmax layer 314B is also applied to the output of the encoder projection layer 316, in order to compute a probability distribution of the encoder projection layer output.

A prediction projection layer 312 and Softmax layer 314A are consecutively applied to the vocabulary predictor output. Because of the additional processing done by the projection layers and Softmax layers, the encoder output and vocabulary predictor output are now able to be combined (e.g., add layer 315) in order to facilitate an improved prediction of the vocabulary token 318. Notably, the blank token 308 is predicted in a similar manner as blank token 208, as described in reference to FIG. 2.

The additional processing is beneficial in allowing the different outputs to be combined because in the unmodified FNT model architecture the vocabulary predictor output

$$( e . g . , {z}_{t}^{v} )$$

is a log probability, while the encoder output is logit.

$${z}_{t}^{v} = log\_softmax ( {d}_{t}^{v} )$$

According to Bayes' theorem, the acoustic and language model scores should be combined by weighted sum in the log probability domain. So, by converting the encoder output to a log probability by adding CTC criterion, the encoder output can be added with a weighted log probability of the vocabulary predictor output according to the following:

$${z}_{t , u}^{v} = {z}_{t}^{v} + γ * {z}_{u}^{v}$$

In the above equations, γ is the trainable language model weight.

The acoustic and label representations are fused in the following manner, in reference to the following equations which represent the functional processing of audio data within the different layers of the factorized neural transducer.

The blank token

$$( e . g . , {z}_{t , l}^{B} )$$

is predicted by combining the acoustic representation, also referred to as the encoder output, (e.g., hₜ) with the blank predictor output (e.g., Pred^{B}) which was generated by the blank predictor based on a previously predicted label (e.g., y≤l).

$${z}_{t , l}^{B} = Joint ( {h}_{c} , {Pred}^{B} ( y \leq l ) )$$

After the vocabulary predictor generates the vocabulary predictor output (e.g., Pred^{V}) based on a previously predicted label (e.g., y≤l), a Softmax layer is applied to the vocabulary predictor output to generate the probability distribution for the vocabulary predictor output. This is also equal to the predicted probability of the language model (e.g., P_{LM}).

$${z}_{l}^{V} = log\_softmax ( P r e {d}^{V} ( y \leq l ) )$$

$${z}_{l}^{V} = log {P}_{L M} ( {\hat{y}}_{l + 1} \vert y \leq l )$$

In addition to being combined with the blank predictor output, the encoder output is also processed by a projection layer (e.g., Proj. (hₜ)). A Softmax layer is also applied to the processed encoder output to generate a probability distribution of the encoder output, which is also equal to the posterior of the CTC sequence (e.g., P_{CTC}).

$${z}_{t}^{V} = log\_softmax ( Proj . ( {h}_{t} ) )$$

$${z}_{t}^{V} = log {P}_{CTC} ( {π}_{t} \vert {x}_{\leq t} ) )$$

The probability distribution of the blank predictor output

$$( e . g . , {z}_{t}^{V} )$$

and the probability distribution of the vocabulary predictor output

$$( e . g . , {z}_{l}^{V} )$$

are combined, where the probability distribution of the vocabulary predictor output is weighted with a learnable parameter (e.g., β). This process generates the prediction of the vocabulary token

$$( e . g . , {z}_{t , l}^{V} ) .$$

$${z}_{t , l}^{V} = {z}_{t}^{V} + β {z}_{l}^{V}$$

The final output, or predicted label, (e.g., P_{ASR}(ŷₗ₊₁|x_{≤t},y₁)) from the factorized neural transducer is generated by a Softmax layer to the combination of the blank token

$$( e . g . , {z}_{t}^{V} )$$

and the weighted vocabulary token

$$( e . g . , β {z}_{l}^{V} ) .$$

$${P}_{A S R} ( {\hat{y}}_{l + 1} \vert {x}_{\leq t} , {y}_{1} ) = softmax ( [ {z}_{t}^{V} + β {z}_{l}^{V} ] )$$

The modified factorized neural transducer loss is computed by combining the loss from the transducer, the language model loss multiplied by a language model loss hyper-parameter, and the CTC loss multiplied by a CTC hyper-parameter, as represented by the following:

$$ℒ = {ℒ}_{transducer} + {λ}_{L M} {ℒ}_{L M} + {λ}_{C T C} {ℒ}_{C T C}$$

The inclusion of CTC criterion allows the encoder to behave more like an acoustic model.

Additionally, adding the CTC criterion during the training stage of the M-FNT, improves the accuracy of the M-FNT baseline as well as the M-FNT after adaptation to a new domain. In another representation, see equation below, the language model loss is combined with the transducer loss by subtracting the language model loss from the transducer loss and adding the CTC loss. In some instances, a first weighting factor is determined and applied to the language model loss and a second weighting factor is determined and applied to the CTC loss.

$${𝔍}_{f} = {𝔍}_{t} - λ log P ( {y}_{1}^{U} ) + β {𝔍}_{CTC}$$

FIG. 4 illustrates various examples of different methods for modifying the factorized neural transducer to perform long-form speech recognition. One method is to concatenate the language model output and the context encoder output. For better utilization, a context-attention module was also added within the language model. Additionally, the encoder is modified from the factorized neural transducer illustrated in FIG. 2 in that the encoder is extended to a more powerful conformer, which allows the encoder network to implicitly learn and make use of historical speech.

For example, the vocabulary predictor 402 receives input of previously predicted non-blank output (i.e., previous label sequence(s)). The vocabulary predictor 402 comprises a plurality of layers, including a linear layer 408, a self-attention layer 410, a context-attention layer 412, and a subsequent linear layer 414, which is also a transformer layer. The context encoder 404 receives previous historical transcription data (e.g., two or more sentences) to generate a context embedding 406.

As described in more detail below, the context embedding is utilized in one or more integration techniques. In some embodiments, the context embedding 406, for example, is combined with the vocabulary predictor output at or prior to the Softmax layer 416 (which is analogous to Softmax layer 314A In FIG. 3 and/or Softmax layer 214 in FIG. 2). Additionally, or alternatively, the context embedding 406 is received as input to the vocabulary predictor 402, for example, at context-attention layer 412.

The context encoder 404, which is a long-form context encoder encodes previous sentences (or portions of input text data) into a long-form context embedding using one or more techniques. Notably, the context encoder 404 is an additional encoder in either FNT model architecture illustrated in FIG. 3 and/or FIG. 2.

One way is to train the context encoder is from scratch. In some embodiments, the context encoder comprises 8 transformer encoder layers with 8 heads and 512 units. Although encoders of different compositions can also be used.

Another way to train the context encoder is to directly use a pretrained language model, such as a BERT or RoBERTa model. In such embodiments, the RoBERTa model is pre-trained using a large number (e.g., 1 million, 1 billion, or other quantity) of training pairs. During training of the entire M-FNT model, the pre-trained language model (e.g., RoBERTa model) is frozen (i.e., not modified during the training process).

There are also different ways to integrate the long-form contextual embedding into the layers of the M-FNT model. One method is to concatenate the context embedding C with the vocabulary prediction output. In some instances, an auxiliary linear layer is also used to match the dimensions of the context embedding (e.g., C) and the vocabulary predictor output

$$( e . g . , {z}_{l}^{V} ) .$$

For example, a linear layer can be applied according to:

$${z}_{l}^{′ V} = {z}_{l}^{V} + Linear ( C )$$

Additionally, or alternatively, the context embedding further improves the performance of the M-FNT model when it is added at a linear layer of the vocabulary predictor. The linearized context embedding can be integrated with an intermediate vocabulary predictor output (i.e., an output of one of the layers inside the vocabulary predictor). Notably, the combining (e.g., ⊕) is implemented either by concatenation or an element-wise addition. P′=Linear·ReLU(p⊕ Linear(C)) Another method to integrate the long-form context embedding is to add an auxiliary cross-attention layer inside the vocabulary predictor. This cross-attention layer facilitates the integration of the context embedding with the processing of the input to the vocabulary predictor. For example, the original vocabulary predictor processes the input data according to:

$${p}^{i} = MHA ( {p}^{i} , {p}^{i} , {p}^{i} )$$

To modify the vocabulary predictor, the additional layer is added according to the following, where the context embedding replaces a previous layer and/or is added to the previous set of layers within the vocabulary predictor:

$${p}^{i} = MHA ( C , {p}^{i} , {p}^{i} ) , where : {p}^{i} = FFN ( {p}^{i} )$$

In the above equations, “i” is the layer index designating with which layer the intermediate output p is associated, FFN is a feed-forward layer inside the transformer encoder layer, and MHA is the multi-head attention layer, respectively.

With regard to the foregoing, it will be appreciated that there are various modifications that can be made to the factorized neural transducer shown in FIG. 2. Such modifications, as disclosed, can beneficially enable the factorized neural transducer for processing long-form speech information. This is also achieved, in part, by extending the input of the FNT encoder with historical speech processed by the encoder and historical transcription data processed by the context encoder. Using such an extension allows the either encoder to receive longer history and achieve improved training and evaluation.

### Example Methods

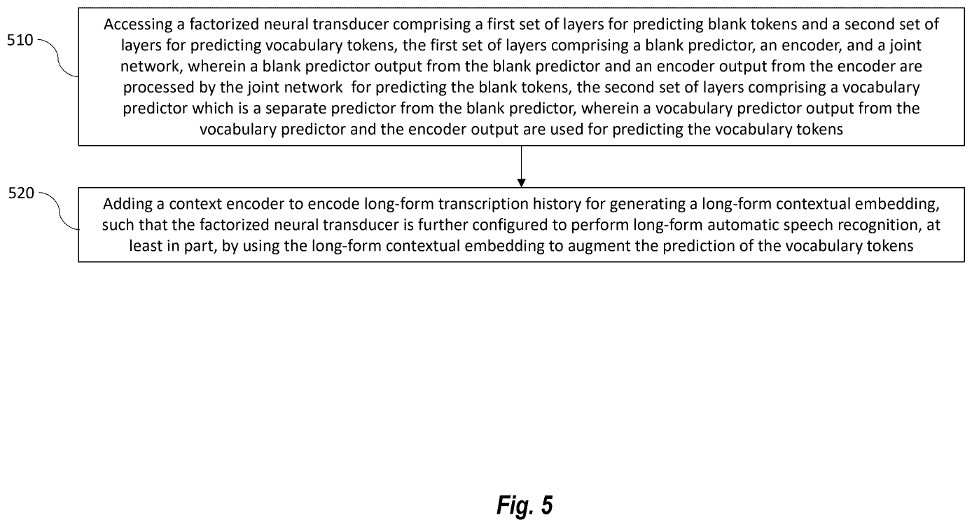

Attention will now be directed to FIG. 5, which illustrates a flow diagram that includes various acts (act 510 and act 520) associated with exemplary methods that can be implemented by computing system 710 for modifying a factorized neural transducer to perform long-form speech recognition.

The first illustrated act includes a computing system accessing a factorized accessing a factorized neural transducer comprising a first set of layers for predicting blank tokens and a second set of layers for predicting vocabulary tokens (act 510). By factorizing the blank prediction network and the vocabulary prediction network, the vocabulary prediction network is able to behave more like a standalone language model, which can be modified and/or adapted without having to modify or adapt the blank prediction network. This allows for greater flexibility and variety in the way the vocabulary prediction network can be modified and/or adapted. For example, the vocabulary prediction network can be adapted to a new domain using text-only data, as opposed to needing audio-text pairs. Additionally, by separating the different prediction networks, the vocabulary prediction network can be modified to interpret and utilize long-form transcription data.

The first set of layers comprises a blank predictor, an encoder, and a joint network, wherein a blank predictor output from the blank predictor and an encoder output from the encoder are processed by the joint network for predicting the blank tokens. The second set of layers comprises a vocabulary predictor which is a separate predictor from the blank predictor, wherein a vocabulary predictor output from the vocabulary predictor and the encoder output are used for predicting the vocabulary tokens.

The computing system then adds a context encoder to the second set of layers. The context encoder consumes long-form transcription history for generating a long-form context embedding, such that the factorized neural transducer is further configured to perform long-form automatic speech recognition, at least in part, by using the long-form context embedding to augment the prediction of vocabulary tokens (act 520).

By generating a long-form context embedding in this manner, the factorized neural network is now able to perform improved automatic speech recognition, especially in long-form speech scenarios, including streaming scenarios.

As described above, disclosed embodiments are directed to a plurality of methods to modify the factorized neural transducer. In some embodiments, modifying the encoder causes the encoder to operate as a conformer encoder for enabling the factorized neural transducer to implicitly learn and use historical speech data.

Additionally, or alternatively, the context encoder is an initially an untrained model encoder which is trained as a long-form context encoder using training data that includes historical transcription data. In some instances, the long-form transcription data is used instead of, or in addition to short-form transcription data as part of the training process.

Another variation of the foregoing method includes using a context encoder that is a pre-trained language model, which is frozen during subsequent training of the factorized neural transducer. In such instances, the pre-trained language model includes, for example, a BERT or RoBERTA model.

Adding a context encoder in this manner allows the context encoder to take in historical transcription data and generate a context embedding which helps the factorized neural transducer to more accurately predict labels for words recognized in long-form speech. In some instances, the context embedding is combined with the vocabulary predictor output. By combining the context embedding with the vocabulary predictor output, the prediction of the vocabulary tokens is augmented with the historical data represented in the context embedding thereby improving the prediction of the vocabulary token. The context embedding is combinable with the vocabulary predictor output using concatenation and/or element-wise addition.

In some instances, the vocabulary predictor output and the context embedding comprise mismatched dimensions. Thus, in order to remedy this mismatch, which would prevent the context embedding from being able to be combined with the vocabulary predictor input, the computing system applies an auxiliary linear layer to the vocabulary predictor output prior to combining the long-form context embedding with the vocabulary predictor output for facilitating matching of dimensions of the vocabulary predictor output with corresponding dimensions of the long-form context embedding.

Additionally, or alternatively, the context embedding is received as input, along with previous label sequences, at the vocabulary predictor. In some instances, the vocabulary predictor is modified by introducing a cross-attention layer inside the vocabulary predictor for causing the vocabulary predictor to generate the vocabulary predictor output based, at least in part, on receiving the long-form context embedding as input at the cross-attention layer.

By injecting the context embedding into the vocabulary predictor, the vocabulary predictor output is augmented with the historical data represented in the context embedding, thereby improving the quality of the vocabulary predictor output.

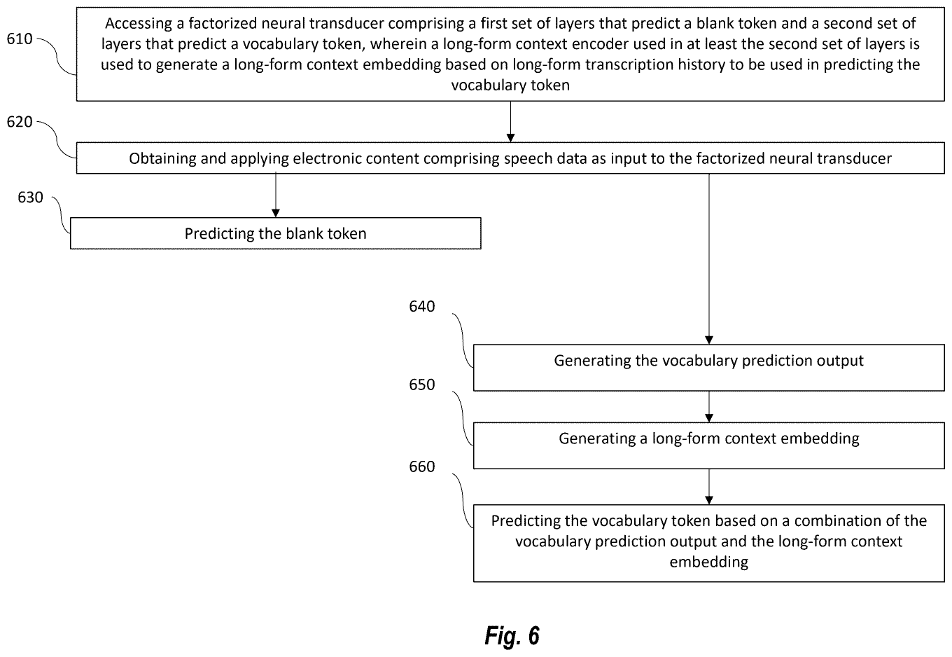

Attention will now be directed to FIG. 6 illustrates a flow diagram that includes various acts (act 610, act 620, act 630, act 640, act 650, and act 660) associated with exemplary methods that can be implemented by computing system 710 for using a factorized neural transducer that has been modified to perform long-form speech recognition.

The first illustrated act includes a computing system accessing a factorized neural transducer comprising a first set of layers that predict a blank token and a second set of layers that predict a vocabulary token, wherein a long-form context encoder used in at least the second set of layers is used to generate a long-form context embedding based on long-form transcription history to be used in predicting the vocabulary token (act 610).

By factorizing the blank prediction network and the vocabulary prediction network, the vocabulary prediction network is able to behave more like a standalone language model, which can be modified and/or adapted without having to modify or adapt the blank prediction network. This allows for greater flexibility and variety in the way the vocabulary prediction network can be modified and/or adapted. For example, the vocabulary prediction network can be adapted to a new domain using text-only data, as opposed to needing audio-text pairs as training data.

Additionally, by separating the different prediction networks, the vocabulary prediction network can be modified to interpret and utilize long-form transcription data. Furthermore, implementing systems and methods in this manner allows for greater flexibility and utilization of the long-form context embedding within the factorized neural transducer in order to improve long-form speech recognition.

The computing system also obtains and receives electronic content comprising speech data as input at the factorized neural transducer (act 620). Using the speech data as input, the computing system predicts the blank token. The computing system also generates a vocabulary prediction output. The computing system is able to predict the blank token separately from the vocabulary token because of the factorization of the different prediction networks.

In addition, the computing system generates a long-form context embedding. Finally, the computing system predicts the vocabulary token based on a combination of the vocabulary prediction output and the long-form context embedding. By generating and utilizing a long-form context embedding, the factorized neural transducer is able to improve the prediction of vocabulary tokens corresponding to words recognized in long-form speech.

In some instances, predicting the blank token further comprises generating a blank representation of a blank predictor output based on a previously predicted non-blank output, generating an acoustic representation of acoustic features for a portion of speech data based on a set of acoustic features extracted from the portion of speech data, and predicting a new blank token based on a combination of the blank representation of the blank predictor output and the acoustic representation of acoustic features.

In some instances, predicting the vocabulary token further comprises projecting the acoustic representation, computing an acoustic probability distribution of the acoustic representation, generating a vocabulary representation for the portion of speech data based on the previously predicted non-blank output, projecting the vocabulary representation, computing a vocabulary probability distribution of the vocabulary representation, and combining the acoustic probability distribution and the vocabulary probability distribution for predicting the vocabulary token.

By processing the acoustic representation and the vocabulary predictor output in this manner, the factorized neural transducer is able to implement CTC criterion which improve the training and/or adaptation processes, as well as improve the accuracy and timing of the vocabulary token prediction.

In some instances, the long-context embedding is utilized to improve the vocabulary predictor output. For example, in some instances, the vocabulary prediction output is generated, at least in part, based on the previously predicted non-blank output and the long-form context embedding.

In view of the foregoing, it will be appreciated that the disclosed embodiments provide many technical benefits over conventional systems and methods for generating and modifying machine learning models for performing long-form speech recognition. By implementing the disclosed embodiments in this manner, many technical advantages over existing systems are realized, including the ability to generate factorized neural transducers which comprise separate prediction networks for predicting blank tokens and vocabulary tokens.

Additionally, system and methods provided herein are directed to embodiments for further modifying the factorized neural transducer including, but not limited to: (1) implementing CTC criterion into the training process to provide for faster, more efficient training processes, with improved prediction functionality, (2) combining the encoder output and vocabulary predictor output prior to generating the vocabulary token prediction to allow learned acoustic information to improve the prediction of the vocabulary token, (3) adding a context encoder which is configured to generate a long-form context embedding, (4) combining the long-form context embedding with the vocabulary predictor output to improve the prediction of the vocabulary token, and/or (5) injecting the long-form context embedding into the vocabulary predictor to improve the vocabulary predictor output.

### Example Computing Systems

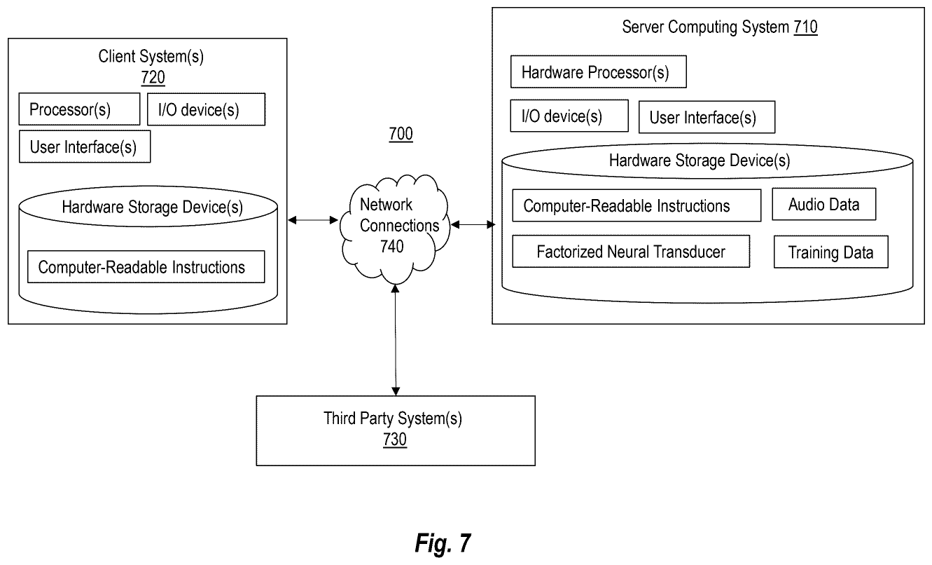

Attention will be first directed to FIG. 7, which illustrates the computing system 710 as part of a computing environment 700 that includes client system(s) 720 and third-party system(s) 730 in communication (via a network 740) with the computing system 710. As illustrated, computing system 710 is a server computing system configured to compile, modify, and implement a factorized neural transducer configured to perform long-form speech recognition.

The computing system 710, for example, includes one or more processor(s) (such as one or more hardware processor(s) and one or more hardware storage device(s) storing computer-readable instructions. One or more of the hardware storage device(s) is able to house any number of data types and any number of computer-readable instructions by which the computing system 710 is configured to implement one or more aspects of the disclosed embodiments when the computer-readable instructions are executed by the one or more hardware processor(s). The computing system 710 is also shown including user interface(s) and input/output (I/O) device(s).

As shown in FIG. 7, hardware storage device(s) is shown as a single storage unit. However, it will be appreciated that the hardware storage device(s) is, a distributed storage that is distributed to several separate and sometimes remote systems and/or third-party system(s). The computing system 710 can also comprise a distributed system with one or more of the components of computing system 710 being maintained/run by different discrete systems that are remote from each other and that each perform different tasks. In some instances, a plurality of distributed systems performs similar and/or shared tasks for implementing the disclosed functionality, such as in a distributed cloud environment.

In some instances, the audio data is natural language audio and/or synthesized audio data. Input audio data is retrieved from previously recorded files such as video recordings having audio or audio-only recordings. Some examples of recordings include videos, podcasts, voicemails, voice memos, songs, etc. Audio data is also retrieved from actively streaming content which is live continuous speech such as a news broadcast, phone call, virtual or in-person meeting, etc. In some instances, a previously recorded audio file is streamed. Natural audio data is recorded from a plurality of sources, including applications, meetings comprising one or more speakers, ambient environments including background noise and human speakers, etc. It should be appreciated that the natural language audio comprises one or more spoken languages of the world's spoken languages. Thus, the factorized neural transducer is trainable in one or more languages.

The training data for the baseline factorized neural transducer comprises spoken language utterances (e.g., natural language and/or synthesized speech) and corresponding textual transcriptions (e.g., text data). The training data comprises text data and natural language audio and simulated audio that comprises speech utterances corresponding to words, phrases, and sentences included in the text data. In other words, the speech utterances are the ground truth output for the text data input. Training data also includes adaptation data which comprises text-only data for new domains on which factorized neural transducer can be adapted.

The computing system is in communication with client system(s) 720 comprising one or more processor(s), one or more user interface(s), one or more I/O device(s), one or more sets of computer-readable instructions, and one or more hardware storage device(s). In some instances, users of a particular software application (e.g., Microsoft Teams) engage with the software at the client system which transmits the audio data to the server computing system to be processed, wherein the predicted labels are displayed to the user on a user interface at the client system. Alternatively, the server computing system is able to transmit instructions to the client system for generating and/or downloading a factorized neural transducer model, wherein the processing of the audio data by the model occurs at the client system.

The computing system is also in communication with third-party system(s). It is anticipated that, in some instances, the third-party system(s) 730 further comprise databases housing data that could be used as training data, for example, text data not included in local storage. Additionally, or alternatively, the third-party system(s) 730 include machine learning systems external to the computing system 710.

Embodiments of the present invention may comprise or utilize a special purpose or general-purpose computer (e.g., computing system 710) including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media (e.g., hardware storage device(s) of FIG. 7) that store computer-executable/computer-readable instructions are physical hardware storage media/devices that exclude transmission media. Computer-readable media that carry computer-executable instructions or computer-readable instructions in one or more carrier waves or signals are transmission media. Thus, by way of example, and not limitation, embodiments of the invention can comprise at least two distinctly different kinds of computer-readable media: physical computer-readable storage media/devices and transmission computer-readable media.

Physical computer-readable storage media/devices are hardware and include RAM, ROM, EEPROM, CD-ROM or other optical disk storage (such as CDs, DVDs, etc.), magnetic disk storage or other magnetic storage devices, or any other hardware which can be used to store desired program code means in the form of computer-executable instructions or data structures and which can be accessed by a general purpose or special purpose computer.

A “network” (e.g., network 740 of FIG. 7) is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmission media can include a network and/or data links which can be used to carry, or desired program code means in the form of computer-executable instructions or data structures, and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general-purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The present invention may be embodied in other specific forms without departing from its essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for using a factorized neural transducer to perform long-form automatic speech recognition, the method comprising:
accessing a factorized neural transducer comprising a first set of layers that predict a blank token and a second set of layers that predict a vocabulary token, wherein a long-form context encoder used in at least the second set of layers is used to generate a long-form context embedding based on long-form transcription history to be used in predicting the vocabulary token;
obtaining and receiving electronic content comprising speech data as input to the factorized neural transducer;
predicting the blank token;
generating a vocabulary prediction output;
generating a long-form context embedding; and
predicting the vocabulary token based on a combination of the vocabulary prediction output and the long-form context embedding.

2. The method of claim 1, wherein predicting the blank token further comprises:
generating a blank representation of a blank predictor output based on a previously predicted non-blank output;
generating an acoustic representation of acoustic features for a portion of speech data based on a set of acoustic features extracted from the portion of speech data; and
predicting a new blank token based on a combination of the blank representation of the blank predictor output and the acoustic representation of acoustic features.

3. The method of claim 2, wherein predicting the vocabulary token further comprises:
projecting the acoustic representation;
computing an acoustic probability distribution of the acoustic representation;
generating a vocabulary representation for the portion of speech data based on the previously predicted non-blank output;
projecting the vocabulary representation;
computing a vocabulary probability distribution of the vocabulary representation; and
combining the acoustic probability distribution and the vocabulary probability distribution for predicting the vocabulary token.

4. The method of claim 2, wherein the vocabulary prediction output is generated, at least in part, based on the previously predicted non-blank output and the long-form context embedding.

5. A method implemented by a computing system for modifying a factorized neural transducer to perform long-form automatic speech recognition, the method comprising:
accessing a factorized neural transducer comprising a first set of layers for predicting blank tokens and a second set of layers for predicting vocabulary tokens,
the first set of layers comprising a blank predictor, an encoder, and a joint network, wherein a blank predictor output from the blank predictor and an encoder output from the encoder are processed by the joint network for predicting the blank tokens,
the second set of layers comprising a vocabulary predictor which is a separate predictor from the blank predictor, wherein a vocabulary predictor output from the vocabulary predictor and the encoder output are used for predicting the vocabulary tokens; and
adding a context encoder to encode long-form transcription history for generating a long-form context embedding, such that the factorized neural transducer is further configured to perform long-form automatic speech recognition, at least in part, by using the long-form context embedding to augment a prediction of vocabulary tokens.

6. The method of claim 5, further comprising:
modifying the context encoder to cause the context encoder to operate as a conformer encoder for enabling the factorized neural transducer to implicitly learn and use historical speech data.

7. The method of claim 6, wherein the context encoder, prior to adding the context encoder to the factorized neural transducer, is an untrained model, and wherein the context encoder is subsequently trained as a long-form context encoder using training data that includes historical transcription data.

8. The method of claim 5, wherein the context encoder is a pre-trained language model, which is frozen during subsequent training of the factorized neural transducer.

9. The method of claim 8, wherein the pre-trained language model is a BERT or RoBERTA model.

10. The method of claim 5, the method further comprising:
applying the long-form context embedding to the vocabulary predictor as input to augment the prediction of vocabulary tokens.

11. The method of claim 5, the method further comprising:
modifying the vocabulary predictor by introducing a cross-attention layer inside the vocabulary predictor for causing the vocabulary predictor to generate the vocabulary predictor output based, at least in part, on receiving the long-form context embedding as input at the cross-attention layer.

12. The method of claim 5, the method further comprising:
combining the long-form context embedding with the vocabulary predictor output prior to generating the prediction of vocabulary tokens.

13. The method of claim 12, wherein the long-form context embedding is combined with the vocabulary predictor output using concatenation.

14. The method of claim 12, wherein the long-form context embedding is combined with the vocabulary predictor output using element-wise addition.

15. The method of claim 12, the method further comprising:
applying an auxiliary linear layer to the vocabulary predictor output prior to combining the long-form context embedding with the vocabulary predictor output for facilitating matching of dimensions of the vocabulary predictor output with corresponding dimensions of the long-form context embedding.
